(19) United States
(12) Patent Application Publication
(10) Pub. No.: US 2005/0097405 A1
(43) Pub. Date: May 5, 2005

(54) Systems and methods for reporting device problems

(76) Inventors: Robert Sesek, Meridian, ID (US); Stephen L. Testardi, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,133

(22) Filed: Nov. 3, 2003

(51) Int. Cl. G06F 11/00

(52) U.S. Cl. 714/48

(57) ABSTRACT

Disclosed are systems and methods for reporting device problems. In one embodiment, a system or a method pertains to collecting device data relevant to diagnosing or fixing a problem encountered by a user of a device, collecting user input regarding the encountered problem, and generating a customized problem report that describes the problem and that includes the collected device data.

### BACKGROUND

Users of shared devices, such as walk-up or peripheral imaging devices (e.g., printers, copiers, scanners, etc.), often experience problems with device use. These problems may comprise device errors that are detectable by the device including, for instance, paper jams. In addition, the problems may comprise device errors that are not detectable by the device including, for example, print quality flaws, operation noises, etc. Furthermore, such users may experience problems with achieving certain desired results (e.g., stapling, collating, etc.) due to the user's lack of knowledge as to how to operate the device to accomplish such results.

When such a problem is experienced by a user, the user will often attempt to work around the problem on the device or simply try using another device. In the case of a device error, if the error condition is not reported to an appropriate person (e.g., system administrator), the condition often times will persist for a significant amount of time and, therefore, will also be experienced by one or more subsequent users, thereby negatively affecting productivity for multiple persons at the device location (e.g., business office).

There are several reasons why device errors or other user problems go unreported. For one, there normally is no simple way to report the problem. For instance, although a user that discovered an error condition could consult a system administrator who is familiar with the device, the user may not know who that person is or how to get in touch with them, particularly in large corporate environments. Even when such a person is reached, the user may need to accurately convey the nature of the problem to the administrator, despite not being as familiar with its configuration or operation.

In an alternative solution, the user can obtain customer support from the device manufacturer. To do this, the user must go to a telephone, such as the user's office telephone, locate the customer support telephone number (e.g., via the Internet), call the customer support line, and wait in a queue until a customer support representative becomes available. This process may require a significant time investment. Furthermore, once the user reaches the representative, the user may be asked to provide various device information (e.g., device model number, serial number, firmware version, etc.) which may require the user to travel back to the device, collect the information, and return to the telephone, thereby wasting even more time.

As can be appreciated from the foregoing, the difficulty associated with reporting device errors results in many such errors not being reported for an extended period of time. Therefore, it would be desirable to have a system and method with which such errors could be reported more easily and thus more quickly fixed. Furthermore, it would be desirable to have a system and method with which other user problems, such as lack of knowledge as to how to accomplish a desired result, can be reported and, therefore, potentially remedied.

### SUMMARY OF THE DISCLOSURE

Disclosed are systems and methods for reporting device problems. In one embodiment, a system and method pertain to collecting device data relevant to diagnosing or fixing a problem encountered by a user of a device, collecting user input regarding the encountered problem, and generating a customized problem report that describes the problem and that includes the collected device data.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which device problems can be reported.

FIG. 2 is a block diagram of an embodiment of a device shown in FIG. 1.

FIG. 3 is a block diagram of an embodiment of a user computing device shown in FIG. 1.

FIG. 4 is a flow diagram that illustrates an embodiment of a method for reporting a device problem.

FIGS. 5A and 5B comprise a flow diagram that illustrates an embodiment of operation of a problem reporting manager of the device shown in FIG. 2.

FIG. 6 is a flow diagram that illustrates an embodiment of operation of a problem reporting manager of the user computing device shown in FIG. 3.

### DETAILED DESCRIPTION

As described above, device usage problems often go unreported, at least for some period of time, in large part due to the difficulty associated with reporting the problems. This phenomenon is unfortunate whether the problem pertains to a device error or simply to user ignorance as to proper device operation. In the former case, failure to report the error may result in multiple persons being inconvenienced by the error. In the latter case, the user may never receive the training he or she needs to accomplish the desired result.

As is described in detail the following, however, such problems can be quickly and easily reported, or the process required to report the problem initiated, by the user while at the given device. For instance, the user can generate a report using the user interface of the device and that report can either be transmitted to another device or stored in device memory for later access by an appropriate person (e.g., device technician). In another embodiment, the information needed to generate the report (e.g., device configuration information) can be transmitted from the device at which the problem is experienced to a suitable user computing device (e.g., desktop computer) so that the user can add various information to a message (e.g., email message) that will be sent to an appropriate person (e.g., system administrator). Irrespective of the particular process used, problem reporting is facilitated by the system, thereby making it more likely that such problems are reported promptly.

Disclosed herein are embodiments of systems and methods for reporting device problems. Although particular embodiments are disclosed, these embodiments are provided for purposes of example only to facilitate description of the disclosed systems and methods.

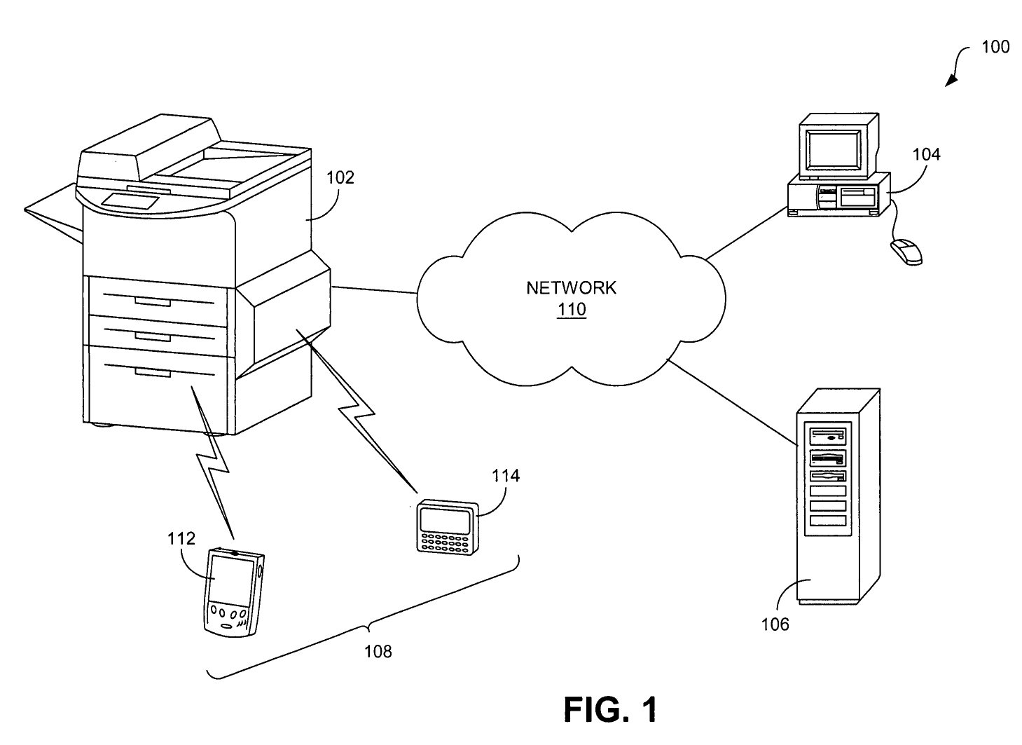

Referring now in more detail to the drawings, in which like numerals indicate corresponding parts throughout the several views, FIG. 1 illustrates an example system 100. As indicated in that figure, the system 100 generally comprises a device 102 with which a user may experience a problem, a user computing device 104, a support computing device 106, and one or more portable devices 108.

The device 102 may comprise, for instance, an imaging device. By way of example, the device 102 comprises a printer, a photocopier, a scanner, a facsimile machine, or a multi-function peripheral (MFP) device which is capable of performing multiple tasks such as printing, copying, scanning, faxing, and emailing. Although particular types of devices have been explicitly mentioned, the device 102 of the system 100 may comprise any device with which a user may experience a problem that is suitable for reporting. Therefore, the device 102 could comprise a non-imaging device that is capable of walk-up and/or peripheral use.

The user computing device 104 can be a local computer that, for instance, shares a local area network (LAN) 110 with the device 102. By way of example, the user computing device 104 is a personal computer (PC) that is located in the user's office (e.g., remote from the device 102). Although a PC is shown in FIG. 1 and has been identified herein, the user computing device 104 could, alternatively, comprise another type of computer including, for instance, a Macintosh computer, a notebook computer, or other computing device that is capable of communicating with the device 102.

The support computing device 106 can comprise, for example, a network server or other computer that is intended to receive problem reports that are generated by a user who experiences a problem with the device 102. The support computing device 106 may be local on the network 110 (e.g., in the case in which the report will be received by a network administrator) or may be remote to the network (e.g., in the case in which the report will be received by a remote support representative or technician) in which case the support computing device communicates to the network via an external network (not shown).

The portable devices 108 may comprise, for example, a personal digital assistant (PDA) 112 or a paging device 114 which is at least capable of receiving wireless (e.g., radio frequency (RF)) communications. As is described below, the portable devices 108 may be possessed and used by a local system administrator that is charged with the duty of receiving reports about problems experienced with the device 102.

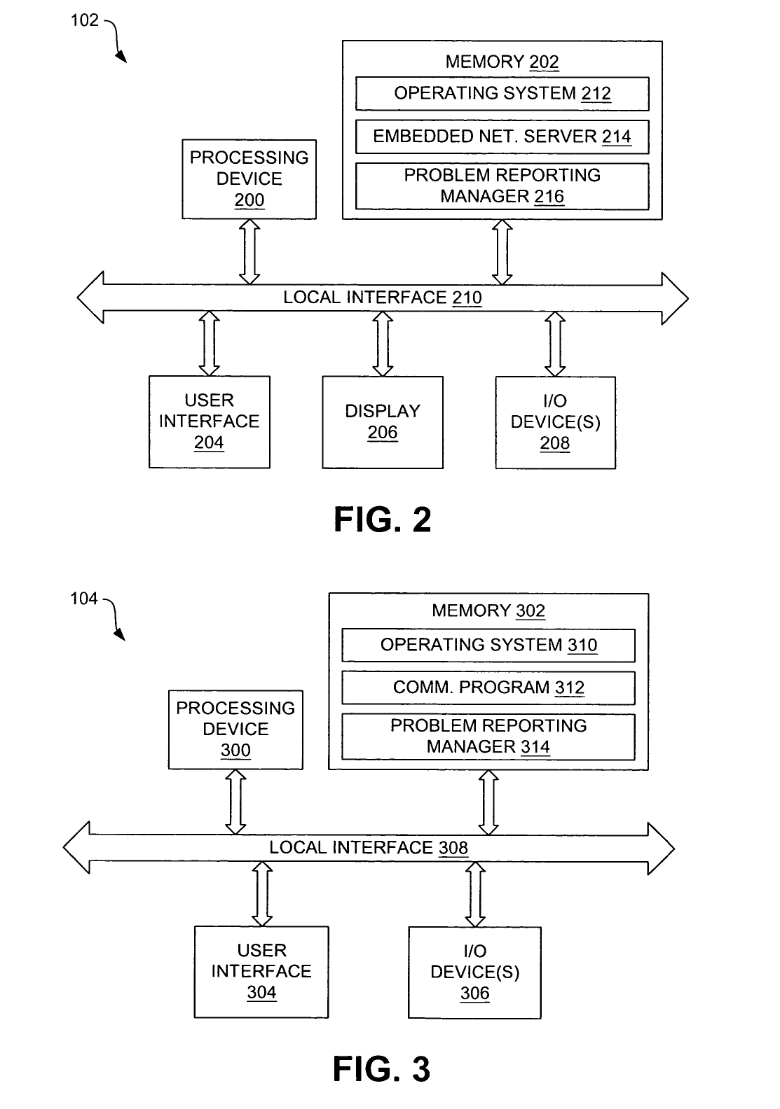

FIG. 2 is a block diagram illustrating an example architecture for the device 102 shown in FIG. 1. As indicated in FIG. 2, the device 102 comprises a processing device 200, memory 202, a user interface 204, a display 206, and at least one input/output (I/O) device 208. Each of these components is connected to a local interface 210 that, by way of example, comprises one or more internal buses.

The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the device 102. The memory 202 comprises any one or a combination of volatile memory elements (e.g., random access memory (RAM)) and nonvolatile memory elements (e.g., read-only memory (ROM), Flash memory, hard disk, etc.).

The user interface 204 comprises the tools with which the device settings can be changed and through which users can communicate commands to the device 102. By way of example, the user interface 204 comprises one or more function keys and/or buttons contained within a device control panel such as those already integral to the design. The keys and/or buttons may include a dedicated problem reporting button, the use for which being described below. Optionally, the user interface 204 can include a separate device, such as a PDA that is adapted to wirelessly communicate with the device 102. In addition, the user interface 204 may comprise an audio recording device, such as a microphone, which may be used to record spoken user comments regarding the problem that the user encountered.

The display 206 may also be provided in a device control panel. Regardless, the display 206 is configured to present visual information to the user, such as status notifications, error condition notifications, settings information, etc. As is described in more detail in the following, the user interface 204, and in some embodiments the display 206, can be used to report a problem that the user is having with the device 102, or to at least initiate the problem reporting process.

The one or more I/O devices 208 facilitate communications with other devices over the network 110 or wirelessly, and therefore may include one or more of a modulator/demodulator (e.g., modem), network card, wireless (e.g., RF) transceiver, or other such communication component.

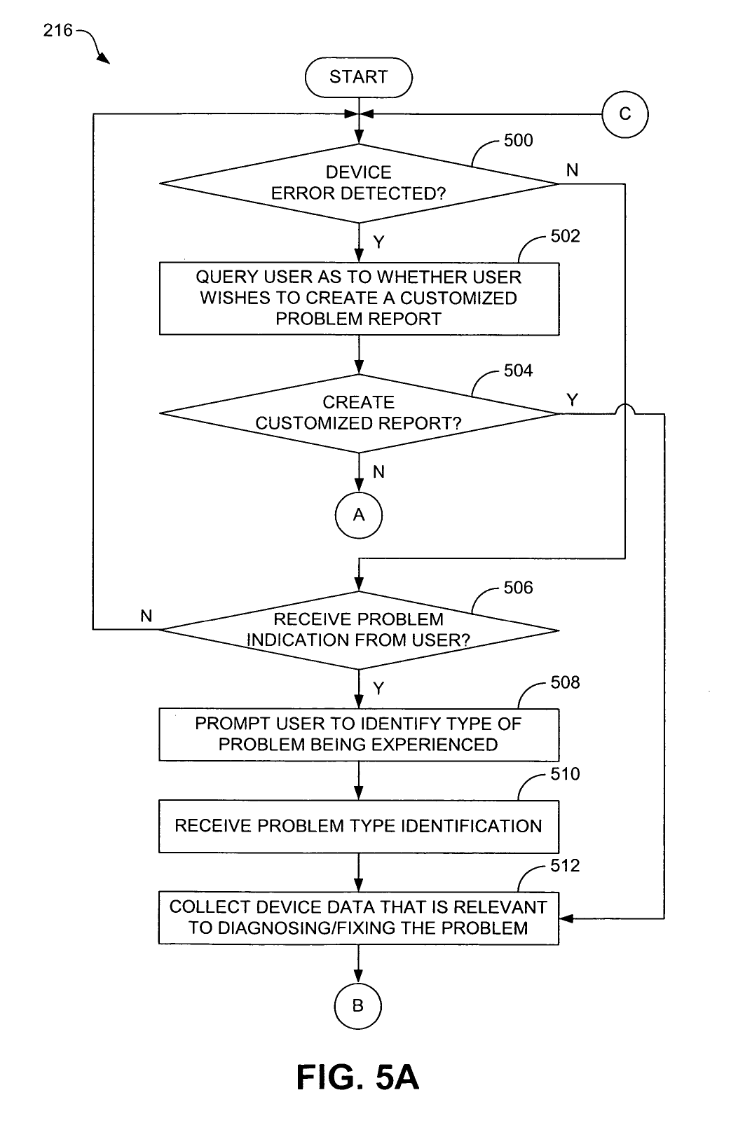

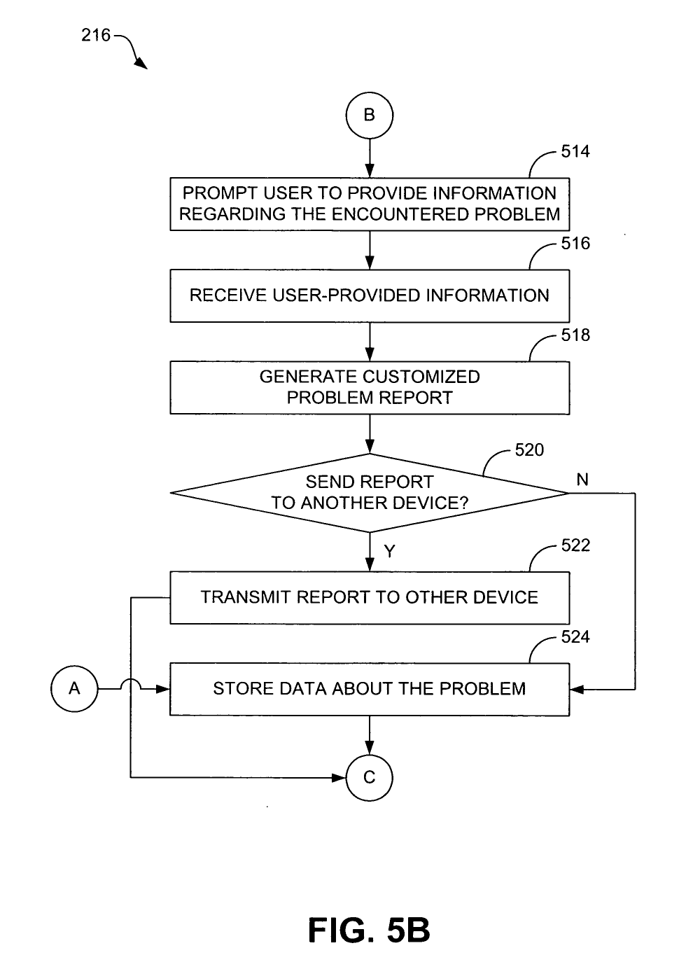

The memory 202 includes various programs including an operating system 212, an embedded network (e.g., Web) server 214, and a problem reporting manager 216. The operating system 212 controls the execution of other programs and overall operation of the device 102. The embedded network server 214 is configured to post and/or transmit information concerning device configuration and status, and, in some embodiments, device problem reports. The problem reporting manager 216 comprises logic that is used to, for instance, collect data that is relevant to a problem the user is having, and at least initiate the problem reporting process. Examples of operation of the problem reporting manager 216 are described in detail in relation to FIGS. 4-5.

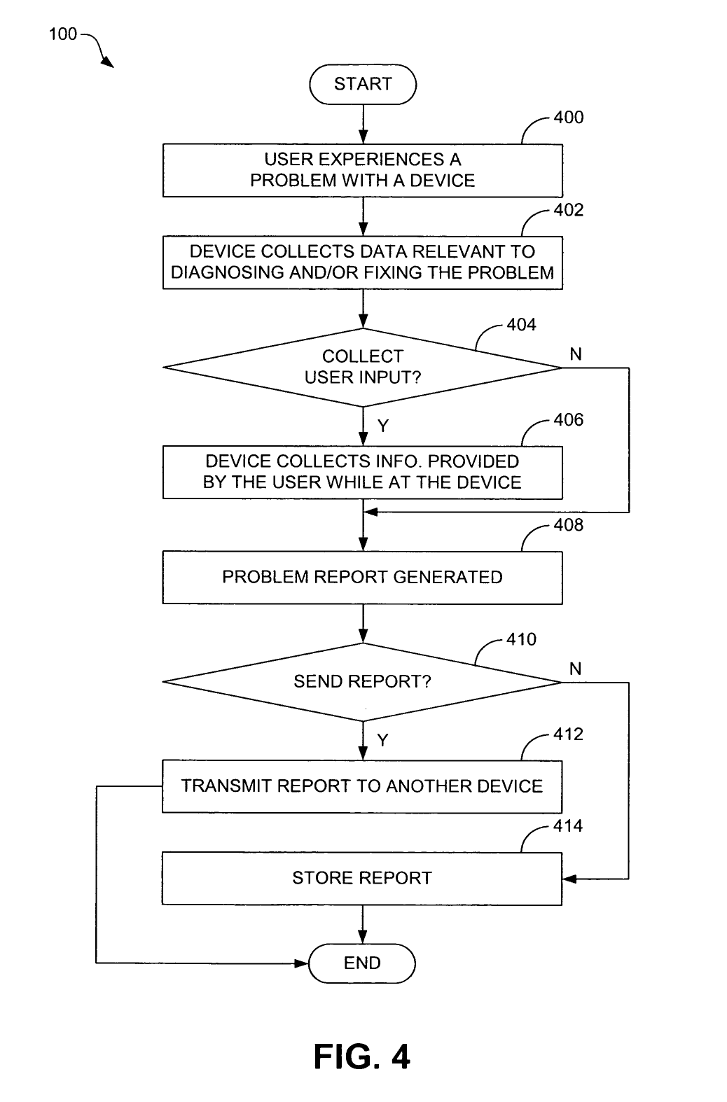

FIG. 3 is a block diagram illustrating an example architecture for the user computing device 104 shown in FIG. 1. As indicated in FIG. 3, the user computing device 104 comprises a processing device 300, memory 302, a user interface 304, and at least one I/O device 306, each of which is connected to a local interface 308.

The processing device 300 can include a central processing unit (CPU) or an auxiliary processor among several processors associated with the user computing device 104, or a semiconductor based microprocessor (in the form of a microchip). The memory 302 includes any one of or a combination of volatile memory elements (e.g., RAM) and nonvolatile memory elements (e.g., hard disk, read only memory (ROM), tape, etc.).

The user interface 304 comprises the components with which a user interacts with the user computing device 104, such as a keyboard and mouse, and a device that provides visual information to the user, such as a cathode ray tube (CRT) or liquid crystal display (LCD) monitor.

With further reference to FIG. 3, the one or more I/O devices 306 are adapted to facilitate network-based communications and therefore include one or more communication components such as a modulator/demodulator (e.g., modem), wireless (e.g., (RF)) transceiver, a telephonic interface, a bridge, a router, etc.

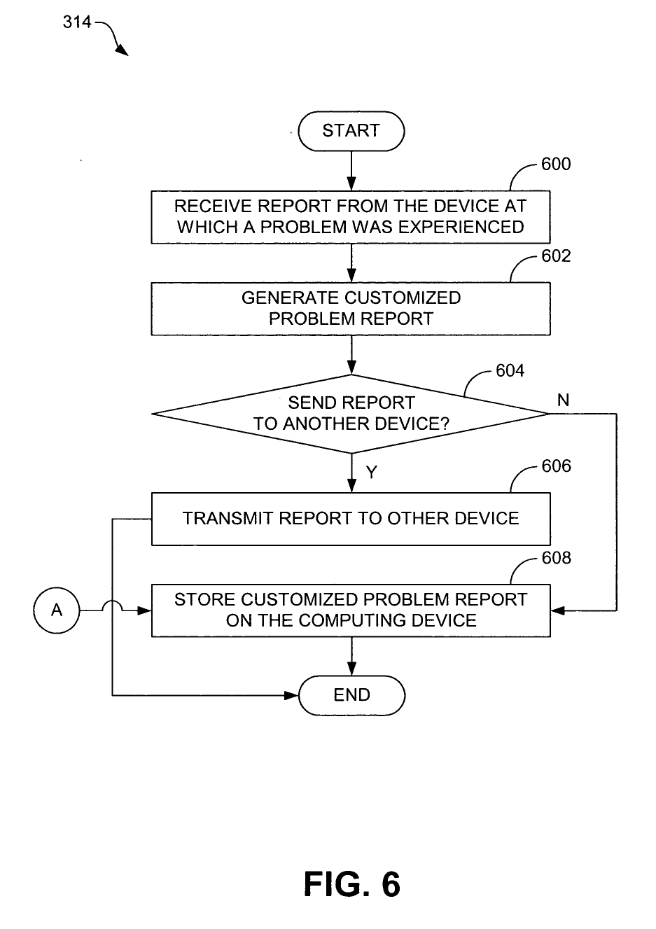

The memory 302 comprises various programs including an operating system 310, a communication program 312, and a further problem reporting manager 314. The operating system 310 controls the execution of other programs and provides scheduling, input-output control, file and data management, memory management, and communication control and related services. The communication program 312 enables the user to send communications to other devices, typically via the network 110. By way of example, the communication program 312 comprises an email or a facsimile program. The problem reporting manager 314 is configured to receive communications sent from the device 102, or a device acting on the behalf of the device 102, and generate an error report to be sent to an appropriate person (e.g., system administrator or support representative or technician). Examples of operation of the problem reporting manager 314 are described below in relation to FIG. 6.

Various programs have been described herein. These programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, examples of operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

As identified above, embodiments of the disclosed systems and methods can be used to enable simple reporting of problems experienced with use of a device, such as an imaging device. FIG. 4 provides an overview of one method for reporting such a problem. Beginning with block 400, a user experiences a problem with a device. The problem can comprise any problem that the user experiences in association with use of the device. For instance, the problem may comprise a device error that is detectable by the device, such as a paper jam, a device error that is not detectable by the device, such as a print quality flaw, or a problem that the user has in achieving a certain desired result that, for example, relates to the user's lack of knowledge as to how to operate the device to accomplish the desired result (e.g., the need for certain procedures or order of task execution).

Irrespective of the nature of the problem that the user is experiencing, the device can collect data relevant to diagnosing and/or fixing the problem, as indicated in block 402. The nature of the data that is collected can depend upon the specific type of problem that is being experienced. The type of problem being experienced can be determined by the device by, for instance, detection of a device error or receipt of a user input that identifies the problem to the device. The collected data may comprise, for example, the device model, the device serial number, the year the device was manufactured, the firmware version that the device is running, the configuration of the device (e.g., what auxiliary devices the device includes), the various settings currently selected for device operation, the Internet protocol (IP) address of the device, the media access control (MAC) address of the device, the various current page counts for the device (or other usage data), the type of media (e.g., paper) the device is using, the physical location of the device (e.g., building number and floor), device status/error log information, and the like.

Flow from this point may depend upon whether input is to be collected from the user, as indicated in decision block 404. In particular, flow may depend upon whether the user will provide information, such as a user-provided description of the problem that was encountered and the conditions in which the problem was encountered. If no such user input is to be collected, flow continues down to block 408 described below. If user input will be provided, however, flow continues to block 406 at which the device collects information provided by the user while the user is at or proximate to the device. The information can be input by the user using any one of a number of interface devices. For instance, the information may be entered using the user interface of the device (e.g., interface 204, FIG. 2), such as via control panel button selections or touch-screen keyboard input. Alternatively, the information can be entered into a separate device, such as a PDA, and transmitted to the device with which the user is experiencing a problem. Irrespective of the manner in which the user input is entered, the input can comprise, as identified above, a description of the problem and the conditions in which it occurred, or identification and/or communication information for the user so as to enable delivery of the data collected by the device (block 402) to another device, such as the user's computing device (e.g., 104 of FIG. 1).

Referring next to block 408, a problem report is generated. This report can be generated by the device, or by another device that received various data from the device, such as the user's computing device. Regardless, the report at least includes the various data that was collected by the device (block 402), and may comprise additional information provided by the user (block 406). In addition or exception, the information can include information that was input by the user at his or her computing device (as will be described in relation to FIG. 6).

At this point, a problem report has been created and is ready for storage on a device or for transmission to another device. With reference to decision block 410, if the report is not to be sent to another device, flow continues to block 414 at which the report is stored on a device (e.g., device 102 or user computing device 104). Alternatively, however, if the report is to be sent, flow continues to block 412 at which the report is transmitted to another device (e.g., support computing device 106). Such transmission could comprise, for example, an email message, a facsimile transmission, wireless transmission, or substantially any network transmission. At this point, flow for the current problem reporting session is terminated.

FIGS. 5A and 5B provide an example of operation of the problem reporting manager 216 of the device 102. In this example, the problem reporting manager 216 is activated along with activation (e.g., power up) of the device 102 so that the manager is prepared for any problem that may arise. Beginning with block 500 of FIG. 5A, the problem reporting manager 216 determines whether a device error is detected. By way of example, this error may comprise a paper jam, an error with peripheral equipment (e.g., high-capacity input device, stapling device, folding device, etc.), job processing error I/O communication errors, etc. If no such device error is detected, flow continues down to decision block 506 described below. If a device error is detected by the problem reporting manager 216, however, flow continues to block 502 at which the manager queries the user as to whether the user wishes to create a customized problem report. A customized error report will include user input of some kind in addition to the device-tracked error data as opposed to a mere error record stored in an error log of the device. The querying of the user can be accomplished by, for example, a presenting text message in the display 206 of the device 102. Alternatively, this querying may comprise activation of a dedicated problem report button included in the control panel of the device 102. For instance, when a device error is detected, such a button can begin to flash on and off to indicate the user that he or she can create a customized error report, if desired.

With reference next to decision block 504, if the user does not wish to create a customized problem report, flow continues down to block 524 of FIG. 5B described below. If, on the other hand, the user does wish to create a customized problem report, as indicated to the device by receipt of an appropriate user input, flow continues down to block 512 also described below.

Returning to decision block 500, if no device error is detected by the problem reporting manager 216, flow continues to decision block 506 at which the manager determines whether a problem indication is received from the user, for instance by user input entered via the user interface 204 (e.g., one or more button and/or menu selections). If not, presumably no problems are being experienced and flow returns to decision block 500 described above. If, on the other hand, the problem reporting manager 216 receives an indication of a problem from the user, flow continues to block 508 at which the problem reporting manager 216 prompts the user to identify the type of problem that is being experienced. For instance, the problem reporting manager 216 can present one or more multiple choice questions to the user with the display 206. In such a case, the problem reporting manager 216 can prompt the user to indicate whether the problem pertains to, for example, print quality or achieving a result that the user does not know how to attain (e.g., collating, creating bound documents, etc.).

After prompting the user, the problem reporting manager 216 can receive the problem type identification, as indicated in block 510. At this point, the problem reporting manager 216 can collect device data that is relevant to diagnosing and/or fixing the problem. Notably, this data may be collected after the problem reporting manager 216 detected a device error and received an indication from the user to create a customized report (blocks 500-504). Given that the particular problem is known (either through detection or from user input), the problem reporting manager 216 can collect the data that is most relevant to that particular problem. As identified above in relation to FIG. 4, the collected data may comprise, for example, one or more of the device model, the device serial number, the year the device was manufactured, the firmware version that the device is running, the configuration of the device (e.g., what auxiliary devices the device includes), the various settings currently selected for device operation, the internal protocol (IP) address of the device, the machine access control (MAC) address of the device, the current page count for the device, the type of media (e.g., paper) the device is using, the physical location of the device (e.g., building number and floor), device status/error log, and the like.

Referring next to block 514 of FIG. 5B, the problem reporting manager 216 prompts the user to provide information regarding the encountered problem. This information may comprise, for example, answers to further questions posed to the user, as well as user comments that describe the problem in greater detail. When user comments are received, they can be input by the user using a keyboard or key pad of the device 102, a separate device (e.g., PDA), or may comprise spoken comments recorded by the device via a device microphone. Notably, this type of information permits the user to customize the problem report, and further provides the user with an opportunity to describe the problem immediately after it is encountered, thereby increasing the likelihood that the user will in fact generate the report and that the report will contain the necessary information for isolating and solving the problem. In addition or in exception to that information, the user can further provide print data to the device, for instance by scanning one or more printed pages into the device 102. This print data may take the form of a printed survey sheet that is then scanned back in the device. Such print data may further help diagnose and/or fix the problem being experienced, especially in cases in which the problem relates to print quality. The user-provided information is then received by the problem reporting manager 216, as indicated in block 516.

At this point, various device and user-provided information has been collected. Accordingly, as indicated in block 518, the problem reporting manager 216 can generate a customized problem report. Flow from this point then depends upon what is going to be done with the generated problem report. With reference to decision block 520, the problem reporting manager 216 determines whether to send a report to another device. This determination can be made with reference to a device setting or user selection. By way of example, the report can be transmitted via the network 110 to the support computing device 106. Such a communication may comprise, for instance, an email message, facsimile message, or other network communication. Alternatively, the report can be transmitted via a wireless communication to a portable device 108 (e.g., PDA 112 or paging device 114) that is possessed and used by a local system administrator. Furthermore, the report can be sent to the user's own computing device (e.g., user computer device 104).

If the problem report is not to be sent, flow continues to block 524 at which data about the problem is stored on the device 102 (e.g., to a hard disk of the device). The nature of this data depends upon the flow described above. For instance, if the user opted at decision block 504 (FIG. 5A) to not create a customized report, the data stored may only comprise data noting an instance of a given error, for instance in a device error log. If, however, the user opted at decision block 520 not to send the report, but did provide various information to add to the report (block 516), the data stored comprises the customized problem report. Even though the customized problem report is not transmitted to another device, useful information is collected and stored and may be collected by, for instance, a device technician that accesses the device on a service call. This increases the likelihood of quickly and accurately troubleshooting and fixing an issue, thus reducing the likelihood of return service calls and therefore reducing device support costs and customer frustration.

Returning to decision block 520, if the problem report is to be sent to another device, flow continues to block 522 at which the report is transmitted to the other device. As noted above, the transmission can be directed at a system administrator or support representative. Accordingly, that person can obtain detailed information about the problem being experienced and, presumably, can take appropriate action to remedy the problem. Alternatively, the report can be transmitted to the user computing device 104 for the purpose of storing the report on that device, forwarding the report to another device from the computing device, and/or adding further user-provided information (e.g., with a keyboard of the computing device). Such operation is described below in relation to FIG. 6. In another alternative, the device error report may be transmitted to more than one other device such as computing device 104 and 106.

Irrespective of whether the problem report was transmitted or simply stored on the device 102, flow then returns to decision block 500 of FIG. 5A so that any newly-experienced problems can be detected and/or reported.

FIG. 6 provides an example of operation of the problem reporting manager 314 of the user computing device 104. The problem reporting manager 314 may be implicated when a problem report is transmitted from the device 102 to the user computing device 104 (block 522 of FIG. 5B). With reference then to block 600, the report transmitted by the device 102 is received. Next, the problem reporting manager 314 generates its own customized problem report, as indicated in block 602. That problem report may simply comprise data contained in the report received by the device 102 and may comprise a reconfigured version of that report (e.g., reconfigured as a word processing file such as a Microsoft Word file).

With reference next to decision block 604, flow continues depending upon whether the report is to be sent to another device. By way of example, the report can be transmitted via the network 110 to the support computing device 106. Such a communication may comprise, for instance, an email message to which the generated report (block 602) is appended as a file attachment, or another network communication. In the former case, the problem reporting manager 314 may generate an email message in which the user can add comments, such as text entered via a keyboard of the user computing device 104 or save file attachments. In addition, that email message can automatically be directed to the appropriate support person (e.g., network administrator or support representative) via, for example, automatic entry of that person's email address in the “To:” block of the email message. Alternatively, the problem report manager 314 can generate a problem report template in which the user can add comments.

If the problem report is not to be sent, flow continues to block 608 at which the problem report is stored on the user computing device 104 (e.g., on a hard disk of the computing device). If, on the other hand the problem report is to be sent to another device (e.g., support computing device 106), flow continues to block 606 at which the report is transmitted to the other device. At that point, flow for the problem reporting session is terminated.

1. A method for reporting device problems, the method comprising:
collecting device data relevant to diagnosing or fixing a problem encountered by a user of a device;
collecting user input regarding the encountered problem; and
generating a customized problem report that describes the problem and that includes the collected device data.

2. The method of claim 1, wherein collecting device data comprises collecting data pertaining to an imaging device with which the user has encountered the problem.

3. The method of claim 1, wherein collecting device data comprises collecting one or more of a device model, a device serial number, a year the device was manufactured, a firmware version that the device is running, a configuration of a device, settings currently selected for device operation, an Internet protocol (IP) address of the device, a media access control (MAC) address of the device, a current page count for the device, a type of media the device is using, and a physical location of the device.

4. The method of claim 1, wherein collecting user input comprises collecting user input at the device.

5. The method of claim 1, wherein collecting user input comprises collecting user input at a separate user computing device that received the collected device data from the device with which the problem was encountered.

6. The method of claim 1, wherein collecting user input comprises at least one of receiving answers to questions presented to the user and comments regarding the encountered problem that are provided by the user.

7. The method of claim 6, wherein collecting the answers or comments comprises recording spoken answers or comments of the user with a microphone of the device.

8. The method of claim 1, wherein collecting user input comprises scanning a printed document that the user has provided for scanning to the device.

9. The method of claim 1, wherein generating a customized problem report comprises generating a customized problem report on the device.

10. The method of claim 1, wherein generating a customized problem report comprises generating a customized problem report on a separate computing device that received the collected device data from the device with which the problem was encountered.

11. The method of claim 1, further comprising detecting a device error and querying the user as to whether to create a customized problem report.

12. The method of claim 1, further comprising receiving a problem indication from a user that was input with a user interface of the device.

13. The method of claim 1, further comprising sending the customized problem report to another device.

14. The method of claim 1, further comprising sending the collected device data to another device for purposes of generating the customized problem report on that other device.

15. A system for reporting device problems, the system comprising:
means for determining when a device problem has been encountered;
means for collecting device data relevant to diagnosing or fixing the problem;
means for collecting user input regarding the encountered problem; and
means for generating a customized problem report that describes the problem and that includes the collected device data.

16. The system of claim 15, wherein the means for determining when a device problem has been encountered comprise means detecting a device error.

17. The system of claim 15, wherein the means for determining when a device problem has been encountered comprise means to receive a problem indication input by a user.

18. The system of claim 15, wherein the means for collecting device data comprise means for collecting one or more of a device model, a device serial number, a year the device was manufactured, a firmware version that the device is running, a configuration of a device, settings currently selected for device operation, an Internet protocol (IP) address of the device, a media access control (MAC) address of the device, a current page count for the device, a type of media the device is using, and a physical location of the device.

19. The system of claim 15, wherein the means for collecting user input comprise a user interface of the device that includes at least one of a button, a display, and a microphone.

20. The system of claim 15, wherein means for collecting user input comprise a user computing device that is in communication with the device with which the problem was encountered.

21. The system of claim 15, wherein the means for collecting user input comprise means for scanning a printed document provided by the user.

22. The system of claim 15, further comprising means for sending the customized problem report to another device.

23. A problem reporting manager stored on a computer-readable medium, the manager comprising:
logic configured to identify a problem encountered with a device by a user;
logic configured to collect device data relevant to diagnosing or fixing a problem;
logic configured to collect user input regarding the encountered problem; and
logic configured to generate a customized problem report that describes the problem and that includes the collected device data.

24. The manager of claim 23, wherein the logic configured to collect device data comprises logic configured to collect one or more of a device model, a device serial number, a year the device was manufactured, a firmware version that the device is running, a configuration of a device, settings currently selected for device operation, an Internet protocol (IP) address of the device, a media access control (MAC) address of the device, a current page count for the device, a type of media the device is using, and a physical location of the device.

25. The manager of claim 23, wherein the logic configured to collect user input comprises logic configured to receive at least one of answers to questions presented to the user and comments regarding the encountered problem that are provided by the user.

26. The manager of claim 23, wherein the logic configured to collect user input comprises logic configured to scan a printed document that the user has provided to the device.

27. The manager of claim 23, further comprising logic configured to detect a device error and logic configured to query the user as to whether to create a customized problem report.

28. The manager of claim 23, further comprising logic configured to receive a problem indication from a user that was input with a user interface of the device.

29. The manager of claim 23, further comprising logic configured to send the customized problem report to another device.

30. A problem reporting manager stored on a computer-readable medium, the manager comprising:
logic configured to receive information transmitted from a device with which a user encountered a problem;
logic configured to generate a customized problem report that is relevant to the encountered problem; and
logic configured to send the customized problem report to another device.

31. The manager of claim 30, wherein the logic configured to generate a customized problem report comprises logic configured to collect user input regarding the encountered problem.
